(19) United States
(12) Patent Application Publication
(10) Pub. No.: US 2003/0180449 A1
(43) Pub. Date: Sep. 25, 2003

(54) Method for applying a pH gradient to a microchannel device

(76) Inventors: John E. Wiktorowicz, San Jose, CA (US); Yefim M. Raysberg, Fremont, CA (US); Xianmin Kwauk, Albany, CA (US)

Correspondence Address: PERKINS COIE LLP, P.O. BOX 2168, MENLO PARK, CA, 94026, US

(21) Appl. No.: 10/322,000

(22) Filed: Dec. 17, 2002

Related U.S. Application Data
(60) Provisional application No. 60/341,916, filed on Dec. 18, 2001.

(51) Int. Cl. B05D 5/12

(52) U.S. Cl. 427/97

(57) ABSTRACT

Methods for controlled application of a composition gradient to a surface, via controlled targeting of droplets of different solutions to a surface region, are disclosed. The methods are especially useful for delivering a gradient of first and second solutions to a microchannel within a microchannel device, by targeting droplets of the different solutions to a surface region within or adjacent an opening of the microchannel.

This application claims priority to U.S. Provisional Application Serial No. 60/341,916, filed Dec. 18, 2001, which is hereby incorporated by reference in its entirety.

### FIELD OF THE INVENTION

The present invention relates to controlled application of a composition gradient to a surface, and more particularly to controlled targeting of droplets of different solutions to a surface region to form a gradient on the surface.

### REFERENCES

Heywang, W. and Thomann, H., Tailoring of piezoelectric ceramics. Annual Review of Materials Science 14: 27-47 (1984).

Okazaki, K., Developments in fabrication of piezoelectric ceramics. Ferroelectrics 41(1-2-3-4): 77-96 (1982).

Polla, D. L. and Francis, L. F. Processing and characterization of piezoelectric materials and integration into microelectromechanical systems. Annual Review of Materials Science 28: 563-597 (1998).

Rosen, C. Z. et al., eds. Piezoelectricity. AIP, New York, N.Y. (1992).

Sayer, M., Fabrication and application of multi-component piezoelectric thin films. Proc. IEEE Int. Symp. Appl. Ferroelectr., 6^{th}: 560-8 (1986).

### BACKGROUND OF THE INVENTION

The method currently used for creating a pH gradient (or any other type of gradient of different chemical substances) on a surface utilizes two or more conventional syringe pumps, each having variable stroke control to dispense a changing volume of reagent stored in a reservoir. Thus, for example, a linear gradient of solution A over an inverse gradient of solution B is accomplished by controlling the stroke length and timing of syringe pump A over syringe pump B in a linear fashion. Mixing of the two solutions occurs post-pump, followed by delivery of the linearly increasing (or decreasing) concentrations of A and B to the surface. Such a technique has been used, for example, to apply a pH gradient to surfaces of a microchannel device for use in separation of materials by isoelectric focusing (IEF), as described, for example, in U.S. Pat. Nos. 6,214,191 and 6,013,165.

This procedure is most satisfactory when the target surface presents a simple geometry, such as a single channel of sufficient volume. Application of a gradient to multiple channels, particularly microscale channels, presents problems created by unequal flow to different channels, regardless of position within a device, or the possibility for convective flow resulting in excessive mixing of gradient as it is being pumped into a device. In addition, as the device increases in size (e.g., has a greater number of parallel channels), overall flow patterns leading to “frowns” within the overall gradient pattern are experienced.

One approach to overcoming this problem is to decrease the flow rate. However, in systems in which the materials being applied undergo a chemical reaction, e.g. polymerization, reduction in flow rate places severe constraints on the reaction chemistry, such that it must be inhibited for an extended time during pumping, but active when the gradient is in place. All of these effects tend to degrade the quality of the final gradient and, in the case of a pH gradient, separation performance.

### SUMMARY OF THE INVENTION

The present invention includes, in one aspect, a method for delivering a gradient of first and second solutions to a microchannel within a microchannel device. In accordance with the method, droplets of said first and second solutions are delivered to a surface region of such a device within the microchannel or within an outlet of the microchannel, from first and second microscale delivery devices, respectively, whereby the droplets mix and are drawn into the microchannel by capillary action. This action results in a gradient of the components of the first and second solutions being formed over the length of the microchannel.

In one embodiment, the microchannel has a roof formed by an upper plate of the device, where the roof includes an outlet to the microchannel, in communication with the microchannel, which opening is bordered by at least one side wall, and droplets are targeted to a region on this side wall. See, for example, FIG. 2. Alternatively, the droplets may be targeted to a region directly within the microchannel. If desired, the droplets can be directed precisely to the target surface point with the use of a strobe and video camera.

The delivery devices may be, for example, piezo-coated capillaries, nozzles within one or more inkjet printer heads, or digitally controlled microvalves. Each droplet typically has a volume in the range of about 3 to about 200 picoliters.

Such a microchannel device typically includes multiple microchannels. A gradient can be delivered to multiple microchannels simultaneously, by employing multiple pairs of first and second delivery devices, or sequentially, by employing a movable pair of first and second delivery devices, e.g. first and second piezo-coated capillaries.

In one embodiment, the first and second solutions contain buffering moieties of varying pKa's, effective to form a pH gradient within the microchannel; i.e. over the length of the microchannel. These buffering moieties may further contain reactive groups for covalently binding to chemically complementary reactive groups on a surface of the channel, to form an immobilized pH gradient within the channel.

The invention particularly addresses problems in current methods of applying gradients to microchannels in a multichannel microfluidic device, such as: variability in the gradients from channel to channel across the width of the plate, due to the microfluidic challenges; the long times necessary to fill the device, in order to avoid curvature in the final gradient (i.e. low flow rate); and the manual nature of the pumping process.

These and other objects and features of the invention will become more fully apparent when the following detailed description of the invention is read in conjunction with the accompanying drawings.

### BRIEF DESCRIPTION OF THE DRAWINGS

FIG. 1 shows an example of a microchannel device to which a gradient may be applied, in accordance with one embodiment of the invention;

FIG. 2 is a schematic diagram showing application of a gradient to a microchannel by piezo coated capillaries, in accordance with one embodiment of the invention; and

FIG. 3 shows a photograph of 29 parallel microchannels filled with a fluorescent dye gradient via a microvalve device programmed to deliver a linear gradient of 5% to 100% fluorescent dye, along with two buffer-filled (background) channels and two dye-filled channels (left side of figure), and plots of fluorescence intensity versus pixel position for 26 of the gradient-filled channels.

### DETAILED DESCRIPTION OF THE INVENTION

I. Definitions

The terms below have the following meanings unless indicated otherwise.

A “microscale” delivery device, as used herein, refers to a device capable of delivering controlled volumes of fluid to a target region, where the controlled volume is in the range of about 3 to 200 picoliters.

“Piezo coated” refers to capillaries which have been coated with a piezoelectric element, such that a controlled voltage delivered to the piezoelectric element is effective to force a droplet of fluid from the capillary. Many crystalline materials, including organic materials such as polyvinylidene fluoride, exhibit piezoelectric behavior, which results from a nonuniform charge distribution within the crystalline unit cell. Examples of piezoelectric materials widely used in commercial applications include quartz, Rochelle salt, lead titanate zirconate ceramics (having various designations such as PZT4, PZT-5A, etc.), polyvinylidene fluoride, ammonium dihydrogen phosphate, potassium dihydrogen phosphate, barium titanate, barium sodium niobate, lithium niobate, lithium tantalate, cadmium sulfide, gallium arsenide, tellurium dioxide, zinc oxide, zinc sulfide, and bismuth germanate.

II. Gradient Delivery Method

The invention provides a method of controlled application of a composition gradient, that is, a coating having a composition which varies along at least one dimension in a predetermined manner, to a surface. In one embodiment, the surface is a microchannel within a microchannel device.

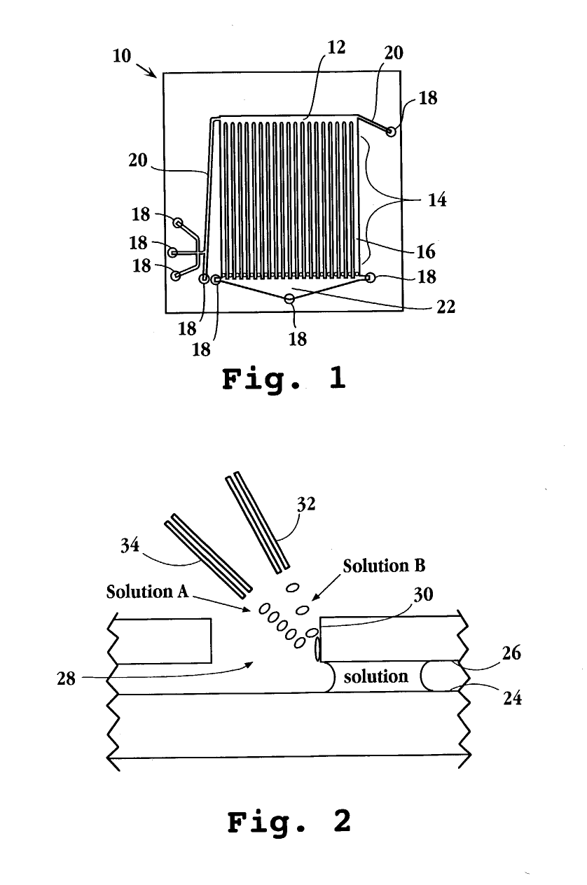

Multichannel devices for conducting two-dimensional electrophoretic separation and isolation of analytes are described in U.S. Pat. Nos. 6,214,191 and 6,013,165 and corresponding PCT Pubn. No. WO 99/61901. One type of such device, as shown at 10 in FIG. 1, comprises two separation regions, i.e. a first electrophoresis region 12 for performing charge and/or size-based electrophoresis in a first dimension, and, below the first electrophoresis region, a second electrophoresis region 14 for performing electrophoresis in a second dimension, in a direction substantially perpendicular to the first dimension. In the device shown, the second separation region comprises a plurality of parallel separation channels 16 aligned in a direction perpendicular to the bottom edge of the plate. Shown is the top view of a bottom plate of the device, having the above features, as well as various ports 18 and additional channels 20, as well as a triangular well region 22, fabricated into the plate. These ports provide access to fluid reservoirs and/or electrodes in the operation of the device, as described in the sources noted above. Preferably, the device also includes a top plate (not shown) of dimensions and material similar to the bottom plate, and having ports corresponding to those shown in the bottom plate. This 2D separation apparatus is adaptable to a variety of separation conditions, including conditions for isoelectric focusing and size-based separations in flowable sieving media.

The microchannel device can be formed of any material suitable for electrophoresis of the selected samples. The plates can be conveniently formed out of a silicon dioxide-based glass, such as borosilicate, although plastics, e.g. polycarbonate, or quartz can also be used. The inner surfaces of the channels may be coated to minimize sample adsorption and/or to control the magnitude of EOF (electroosmotic flow), if desired.

The method of the present invention is especially useful for applying a fixed pH gradient to one or more surfaces of such a device, typically the lower surfaces of the separation channels in the second separation region, for isoelectric focusing. It may of course also be used to apply such pH gradients, or other types of gradients, to other surfaces. In a preferred embodiment, the parallel separation channels are supplied with a pH gradient comprised of a plurality of buffering moieties (e.g., the “Immobiline®” compounds sold by Amersham-Pharmacia Biotech, Uppsala, Sweden). In one embodiment, the gradient molecules are covalently attached to the surface once the desired gradient is introduced. Covalent attachment of buffering groups, particularly “Immobiline®)” molecules, is described in U.S. Pat. No. 6,013,165.

FIG. 2 shows an enlarged region of a microchannel to which a gradient may be applied in accordance with an embodiment of the invention. The channel has a floor 24 formed by the lower plate of the microchannel device and a roof 26 formed by the upper plate of the microchannel device.

The height of a channel, defined as the shortest distance between the floor and roof, is typically in the range of about 50 to 200 _{μ}m, and the width in the range of about 0.25 to 1 mm. A typical volume is about 6 _{μ}L. The roof includes an opening 28 to the channel, bordered by at least one side wall 30.

In accordance with the invention, a composition gradient can be formed on the floor (or other internal surface) of a microchannel by delivering to a surface region within or immediately adjacent the opening of the microchannel, droplets of first and second solutions, from first and second piezoelectric delivery devices 32 and 34, respectively, each operably connected to a piezoelectric pump (not shown). In one embodiment, as illustrated in FIG. 2, the droplets are delivered to a surface point on the side wall bordering the opening to the microchannel. Upon striking the target surface, the droplets mix and are drawn into the channel by capillary action, forming a coating on one or more inner surfaces of the channel. In this way, the channel fills at a rate governed by capillary action and the pulse frequency.

A. Piezo-Coated Capillaries

In one embodiment, the delivery devices are piezo-coated capillaries, as shown schematically at 32 and 34 in FIG. 2. The fabrication and use of piezoelectric materials, such as those noted above, is well known in the art; see, for example, the general references cited above. Commonly used techniques include sputtering and sintering methods. In the first, briefly, a piezoelectric thin film is formed on a substrate by a sputtering method such as physical vapor deposition (PVD), chemical vapor deposition (CVD), or a sol-gel method such as spin coating, and the film is subjected to a heat treatment, typically at 700-1000° C. In the second, a fine powder of the piezoelectric material is formed into the desired shape by cold pressing at high pressure, followed by sintering at approximately 1000-1150° C. or higher in oxygen. These and other known fabrication methods can be employed by one skilled in the art to prepare piezo coated capillaries for use in the present method.

In the piezoelectrically-controlled liquid delivery devices disclosed herein, a piezoelectric crystal surrounds a capillary filled with a solution. Pumping action is achieved by virtue of the deformation and relaxation of the piezoelectric crystal when a voltage pulse of defined frequency and amplitude is applied thereto. This deformation and relaxation result in the release of a droplet of defined volume from the end of the capillary, at a rate generally dependent upon the frequency of the pulses.

In practice, to deliver a gradient formed by varying the flow rate from two solutions, two piezo-coated capillaries are filled from two reservoirs containing solutions A and B, as indicated in FIG. 2. The droplets from these devices can be precisely aimed at the desired surface point using a strobe and video camera. For the embodiment shown in FIG. 2, the droplets are directed through the opening in the top plate of the microchannel device, near the end of a channel on the long capillary side of the hole (FIG. 1). In this way, the channel fills at a rate governed by capillary action and the pulse frequency. By linearly decreasing the frequency of the voltage pulse of solution A's piezo-coated capillary and at the same time increasing the pulse frequency of solution B's capillary, a gradient of solutions from high A to high B can be delivered.

The droplets delivered by the capillaries may have volumes in the range of about 3 to about 200 picoliters, generally in the range of about 100 pL. Each capillary can deliver droplets at frequencies up to about 20 kHz. Using this method, surface attachment of “Immobilines” to microchannels of a multichannel device such as described above, to prepare a pH gradient, can be performed with conventional initiators and catalysts, eliminating the need to inhibit the reaction in order to accommodate a low flow rate.

Chemical reagents, such as initiators, can also be delivered, through a separate capillary of set of capillaries, along with the gradient solutions. Mixing occurs only after the solutions have reached the target, thus eliminating the disadvantage of premature reaction from premixing of solutions.

A gradient can be delivered to multiple channels sequentially, by employing a movable pair of first and second capillaries. Alternatively, a gradient can be delivered to multiple channels simultaneously, by employing multiple pairs of first and second capillaries; or some combination of the two techniques could be used. By using robotic positioners, the gradient coating of plates can be reproducible and automated. Another advantage of this process is that each channel can have a particular gradient delivered to it, if desired.

In an illustration of the procedure, glass capillaries were provided with a piezo element encircling them. The piezo elements were controlled via a voltage frequency modulator which governed the rise-time of the pulse, delay time (i.e. time on the plateau), decay time, echo pulse shape and magnitude (to dampen rebounding waves), and frequency. Aiming of the droplet was accomplished through the use of holders that were adjusted while monitoring the pulses using videocameras. The quality of the droplets was monitored through the use of a strobe coupled to the frequency modulator.

A gradient was applied to microchannels of a device such as shown in FIG. 1, using, as the two solutions, a fluorescent dye solution and a buffer solution without dye. The droplets (˜90 pL) were aimed into the openings near the bottom of the microchannels (nearest the triangular region) of the device. The frequency applied to the dye-containing capillary was varied linearly from 100 to 20%, while the frequency applied to the buffer-containing capillary was simultaneously increased linearly from 20 to 100% of maximum. During application, a flow of about 11 psi of argon was ported into the opening at the apex of the triangular area of the plate device, to prevent the solutions from traveling back opposite to the desired direction.

Color images of the channels were taken under illumination with fluorescent light, and the intensity of dye was measured with an image processing program, which showed the linearity of the fluorescence gradient.

B. Digitally Controlled Microvalves

A linearly varying curve of small volumes can be obtained with a digital valve by using pulse width modulation, also called duty cycle with constant frequency. This could be achieved with two digital two-way normally closed microvalves where the maximum droplet size is less than 400 picoliters. By inversely varying the pulse width at a constant frequency of each of two valves modulating the flow from two reservoirs, a gradient from each of the reservoirs can be created. The outlets of the valves can be connected to a mixing head/needle having a single outlet, or mixed by diffusion after injection into the plate. The mixing needle(s) is inserted into the opening to the channel, and flow from the needle is directed into the channel. Flow rate may be matched to the capillary action drawing the solutions into the channel, or injected by using delivery pressure with a sealing needle to prevent flow in the reverse direction.

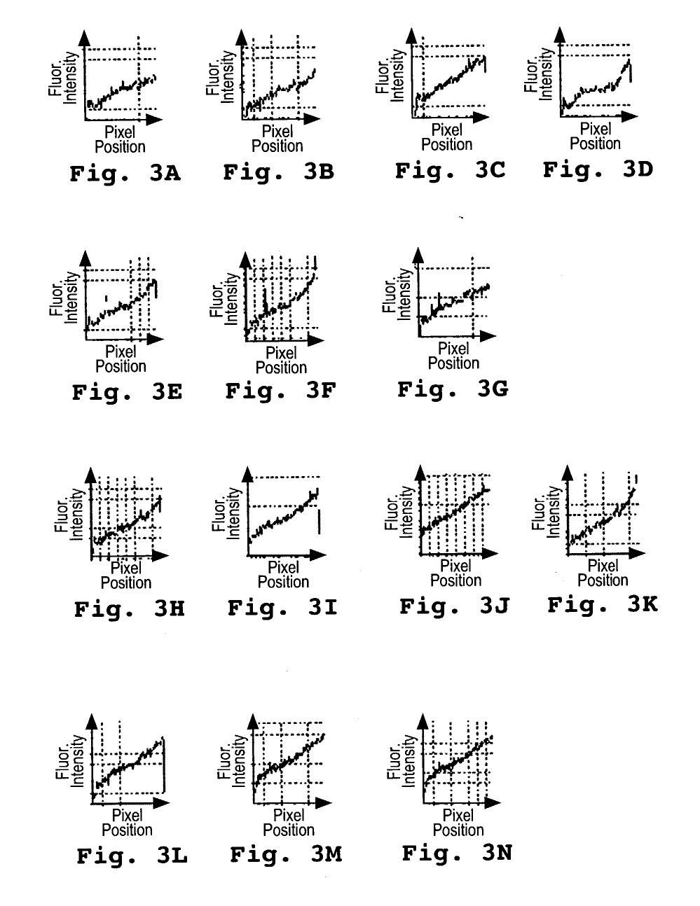

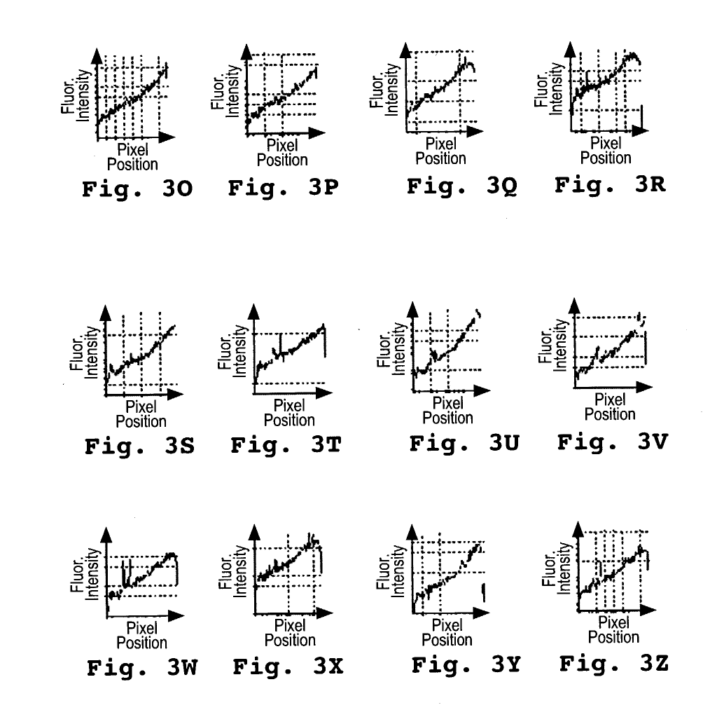

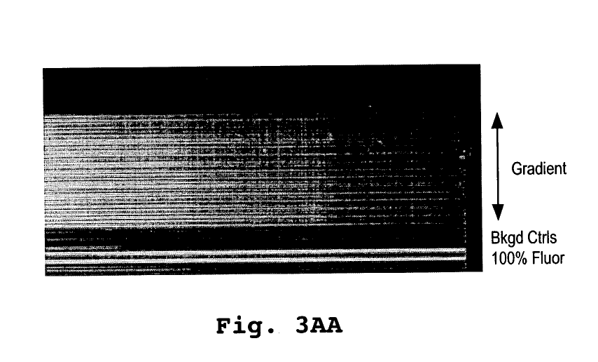

In a further illustration of the process, twenty-nine channels of a microchannel device were filled via an electronically controlled and actuated microvalve device, programmed to deliver a linear gradient of 5% to 100% fluorescent dye. Photographs and image processing analyses of dye intensity for the filled channels are shown in FIG. 3. The two channels marked “Bkgrd” in the Figure, filled with non-fluorescent buffer solution, were used to correct for background fluorescence, while the channels marked “100% fluor”, filled with the highest dye concentration used in filling the adjacent channels, were used to normalize for uneven illumination in the field. Twenty-six of the gradient-filled channels were analyzed for fluorescence signal and the intensity versus pixel position plotted for each channel, as shown in FIG. 3.

C. Inkjet Printer Head

The process can also be carried out using a commercial inkjet printer head or similar device. Piezo controlled color inkjet printer heads, such as produced by Epson, can deliver small (3-4 pL) and precisely formed droplets with great accuracy and at high speed (approx. 4 kHz). Both the charging and firing of the piezo elements can be controlled with a high degree of precision in terms of pressure, timing and speed, so as to provide even droplet volume and precise positioning on the target.

In practice, a plurality of solutions are supplied to the separate reservoirs of a printer cartridge, or to external reservoirs which are connected to the print head. The printer is programmed to deliver the desired number of droplets of the respective solutions, through one or more nozzles of the print head, to a target location. For gradient delivery, multiple solutions (typically two) can be delivered from the same number of sets of nozzles alternately, varying the number of droplets of each solution over time. As noted above, chemical reagents, such as initiators, can also be delivered through a separate set of nozzles, along with the gradient solutions.

While the invention has been described with reference to specific methods and embodiments, it will be appreciated that various modifications may be made without departing from the invention.

It is claimed:

1. A method for delivering a gradient of first and second solutions to a microchannel within a microchannel device, the method comprising:
delivering, to a surface region of said device within or immediately adjacent said microchannel or an outlet of the microchannel, droplets of said first and second solutions, from first and second microscale delivery devices, respectively,
whereby said droplets mix and are drawn into said microchannel by capillary action.

2. The method of claim 1, wherein each said droplet has a volume in the range of about 3 to about 200 picoliters.

3. The method of claim 1, wherein said delivery devices are piezo-coated capillaries.

4. The method of claim 1, wherein said delivery devices are nozzles contained within one or more inkjet printer heads.

5. The method of claim 1, wherein the delivery devices are digitally controlled microvalves.

6. The method of claim 1, wherein said microchannel has a roof formed by an upper plate of said device, and said roof includes an outlet to said microchannel, bordered by at least one side wall, and said surface region is a region on said side wall.

7. The method of claim 1, wherein said device includes multiple microchannels, and a gradient is delivered to multiple microchannels simultaneously, by employing multiple pairs of first and second delivery devices.

8. The method of claim 1, wherein said device includes multiple microchannels, and a gradient is delivered to multiple microchannels sequentially, by employing a movable pair of first and second delivery devices.

9. The method of claim 1, wherein said droplets are directed precisely to said surface point with the use of a strobe and video camera.

10. The method of claim 1, wherein said first and second solutions contain buffering moieties of varying pKa's, effective to form a pH gradient within said channel.

11. The method of claim 10, wherein said buffering moieties further contain reactive groups for covalently binding to chemically complementary reactive groups on a surface of the channel, to form an immobilized pH gradient within said channel.
